(19) United States
(12) Patent Application Publication
(10) Pub. No.: US 2012/0088207 A1
(43) Pub. Date: Apr. 12, 2012

(54) ROOT CANAL LENGTH MEASUREMENT DEVICE

(75) Inventors: Shlomo BERKOVICH, Herzeliya (IL); Arik BECKER, Doar-Na Emek HaYarden (IL); Haim LEVY, Pardes Hana (IL); Uri KATAN, Kfar Sava (IL)

(73) Assignee: MEDIC NRG LTD., Kibbutz Afikim (IL)

(21) Appl. No.: 13/269,783

(22) Filed: Oct. 10, 2011

(30) Foreign Application Priority Data
Oct. 12, 2010 (IL) 208668

(51) Int. Cl. A61C 5/02

(52) U.S. Cl. 433/102

(57) ABSTRACT

A root canal length measurement device configured for detachable support on a neck of a dental handpiece and having a generally cylindrical electrical contact element that, in use, is resiliently biased by a spring toward an endodontic file rotatably mounted in the handpiece so that a flat surface of the contact element maintains a steady electrical connection with a shank portion of the endodontic file proximate its point of attachment to the handpiece.

### CROSS-REFERENCE TO RELATED APPLICATIONS

The application claims priority under 35 U.S.C. §119(a) to Israel patent application No. 208,668, filed Oct. 12, 2010, now pending, the contents of which are incorporated herein by reference in their entirety.

### FIELD OF THE INVENTION

The present invention relates to a root canal length measurement device for endodontic therapy, more particularly to a detachable device that fits different dental handpieces and uses any affixed endodontic file as an electrode for root canal length measurement.

### BACKGROUND OF THE INVENTION

Endodontic treatment involves removal of the damaged pulp, followed by cleaning and shaping of the root canal space, irrigating, and filling with biocompatible material and a root canal sealer.

Shaping of the canal is performed either manually, using hand-held endodontic files or advantageously mechanically. The mechanical process utilize rotary endodontic files such as drills or reamers adapted to fit a standard dental handpiece or a dedicated endodontic handpiece.

An important step in the root canal preparation involves determining the depth of penetration of the endodontic file into the root canal and indicating when penetration reaches the root apex. Modern apex locators electronically detect the proximity of the endodontic file tip to the apical foramen by measuring changes in impedance between the endodontic file while inserted into the root canal and a hook electrode attached to the patient's lip.

Recent developments in the field include the combination of a digital electronic apex locator and a dental handpiece. Dental handpieces for root canal treatment with built-in or integrated root canal length measurement capabilities are described for instance in U.S. Pat. Nos. 7,771,197; 7,476,101 and 7,452,208. Some well established companies such as Morita, NSK and W&H include such devices in their product line. Typically, the combined tools include permanent implementation of root canal length measurement device in a specialized dental handpiece.

Many dentists, however, prefer simple general purpose handpiece units over dedicated units that require frequent interchange of heads, complex maintenance, difficult sterilization procedure and high initial expense.

Additionally, all the above suggested and applied solutions position the electrical contact point with the rotary file along a stem portion (8 FIG. 2a) of the file, located between the cutting portion and the shank. The stem portion considerably protrudes from the handpiece head and hence the electric contact is not steady enough and the protruding contact element restricts the sight of the dentist and generally takes up valuable space required for the delicate work. In cases of deep root canals, the entire free length of the endodontic file is needed including the stem portion, and in such cases the electric contact element must be removed and the treatment carried out without proper root canal length measurement.

Furthermore dedicated handpiece units may use only one of several standards of rotary endodontic files available on the market today since the length of the shank is different for each standard and the electric contact point along the stem must be set to a different location.

US 2007/0026362 to the present applicant describes a coupler device with electrical plug on one side that may be plugged to an apex locator and a contact fork on the other side that may be fitted to a rotary endodontic file separately or while seated in a standard dental handpiece. However, the device is not fixedly attached to the handpiece and significantly protrudes from the handpiece neck, restricting the sight of the dentist.

Consequently a new approach is desired for a root canal length measurement device that addresses the above disadvantages.

### SUMMARY OF THE INVENTION

It is thus an object of the present invention to provide a detachable root canal length measurement device that fits different dental handpieces and uses an affixed endodontic file as an electrode, while imposing minimal interference to the dentist's work.

It is another object of the present invention to provide a steady electrical connection between the endodontic file and the device.

These objects are achieved according to a broad aspect of the invention by a root canal length measurement device configured for detachable support on a neck of a dental handpiece and having a generally cylindrical electrical contact element that, in use, is resiliently biased by a spring toward an endodontic file rotatably mounted in the handpiece so that a flat surface of the contact element maintains a steady electrical connection with a shank portion of the endodontic file proximate its point of attachment to the handpiece.

In accordance with one aspect of the present invention, the device comprises an elongated spring clip configured to grip a neck of the handpiece and supporting at a first end thereof a flat faced spring-loaded contact element directed to maintain a steady electrical connection with a shank portion of said endodontic file proximate its point of attachment to the handpiece.

In accordance with another aspect, the invention provides a device as described above, wherein the flat face of the contact element has a specific diameter and an accurate location designed to provide stable connection with commercially available endodontic files of different sizes and color-coding grooves identifying the file size.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an elevation view of a standard handpiece head equipped with a detachable root canal length measurement device made in accordance with an embodiment of the present invention;

FIGS. 2a, 2b and 2c, are elevation views demonstrating common shank sizes of rotary endodontic files related to different standards;

FIGS. 3a, 3b and 3c, are elevation views of the handpiece and root canal length measurement device as shown in FIG. 1, supporting the different rotary endodontic files as shown in FIGS. 2a, 2b and 2c;

FIGS. 4a and 4b are perspective views of the root canal length measurement device as shown in FIG. 1;

FIG. 5 is an exploded perspective view of a standard handpiece head and a detachable root canal length measurement device as shown in FIG. 1;

FIG. 6 is a perspective view of the components of FIG. 5 shown assembled;

FIGS. 7a and 7b are perspective views of a root canal length measurement device according to a second embodiment of the present invention;

FIG. 8 is an exploded perspective view of a standard handpiece head and a detachable root canal length measurement device as shown in FIGS. 7a and 7b;

FIG. 9 is a perspective view of the components of FIG. 8 shown assembled; and

FIG. 10 is a perspective view of the entire system including connectors, electronic unit, and reference hook electrode.

### DETAILED DESCRIPTION OF EMBODIMENTS

In the following description of some embodiments, identical components that appear in more than one figure or that share similar functionality will be referenced by identical reference symbols.

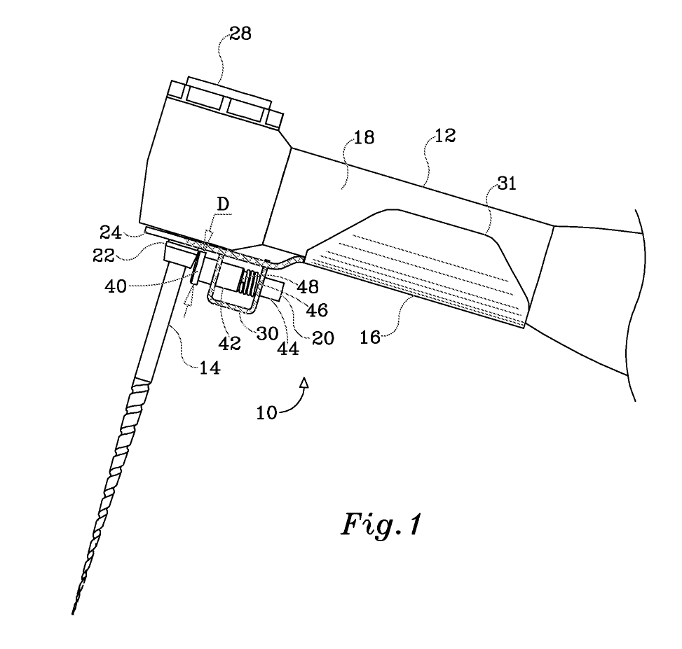

With reference to FIG. 1 there is shown a root canal length measurement device generally referenced 10 that is configured for detachable attachment to a dental hand-piece 12 and uses an endodontic file 14 affixed to the handpiece as an electrode. The device 10 comprises an elongated spring clip 16 that resiliently grips a neck 18 of the handpiece and supports at a forward end proximate the endodontic file 14 a contact element 20 having a generally flat face that is adapted to resiliently abut a shank portion 22 of the endodontic file 14 close to its point of attachment to the handpiece and establish a steady electrical connection therewith.

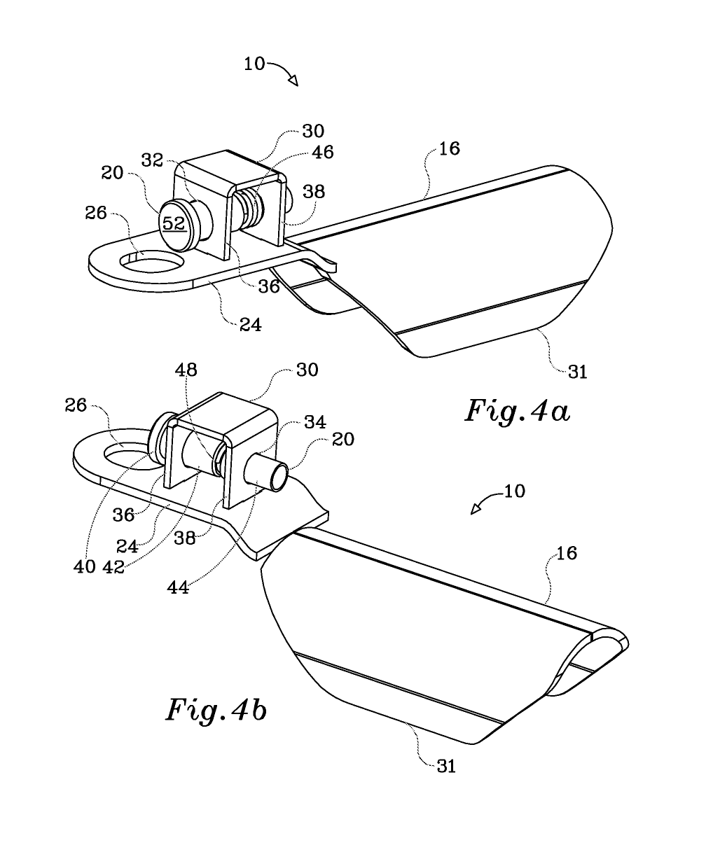

In more detail, referring also to FIGS. 4a and 4b, the elongated spring clip 16 is of C-shaped cross-section that supports a flat extension 24 at its forward end. The spring clip 16 and the extension 24 may be formed of a unitary thin sheet of resilient electrically conductive material, preferably stainless steel. In order to aid alignment of the device, the extension 24 may be elongated so as to overhang the point of attachment in the head 28 of the handpiece and perforated with an elongated hole 26 through which the endodontic file 14 is fitted to and removed from the point of attachment. The contact element 20 is located relative to the center of the elongated hole 26 such that in use, provided the elongated hole 26 overlaps the point of attachment, the contact element 20 will exert effective spring force against an endodontic file inserted into the head 28. If necessary, fine adjustment may then be carried out in order to increase or decrease contact pressure by moving the spring clip 16 of the device 10 along the neck 18 of the handpiece, such movement being facilitated by the fact that the diameter of the elongated hole 26 is significantly greater than that of the endodontic file 14.

The contact element 20 is supported by a holder 30 made of a short tunnel section transversely attached to an outer surface of the extension 24 in an opposite direction to opposing arms 31 of the C-shaped spring clip 16. First and second circular apertures 32 and 34 shown in FIGS. 4a, 4b are formed through opposing front and rear walls 36 and 38, respectively, of the holder 30 so as to be aligned parallel with a longitudinal axis of the device 10. The first aperture 32 facing towards the elongated hole 26, is preferably of larger diameter than the second aperture 34 facing towards the spring clip 16.

The contact element 20 of generally stepped cylindrical form, preferably made of stainless steel, is slidably retained through the first and second apertures 32, 34 of the holder 30. The contact element 20 is made of three coaxial sections: a short flat faced head 40 of largest diameter, a body 42 of mid-diameter and a tail section 44 of smallest diameter. The body section 42 is adapted to slide freely in the first hole 32 of the holder 30 and the tail section 44 is adapted to slide freely in the second smaller hole 34.

A helical coil compression spring 46 with internal diameter slightly larger than that of the tail section 44 is fitted to the contact element around the tail section 44 so that one end of the spring 46 abuts a shoulder portion 48 between the body 42 and the tail section 44, while its opposite end abuts an internal surface of the rear wall 38 of the holder 30. The spring 46 is made of electrically conductive metal, preferably stainless steel. In general, helical coil springs generate more steady and repeatable force compared to leaf springs such as used by prior art designs. However, the invention may be realized by other forms of resilient bias that acts on the cylindrical contact element so as to urge it toward the shank of the file. For example, a leaf spring mounted toward a rear end of the contact element could be used to apply pressure on the contact element and urge it toward an endodontic file rotatably mounted in the handpiece proximate its point of attachment to the handpiece. What is important is that the spring force be sufficient to maintain good contact regardless of any slight non-uniformity in the contour of the endodontic file or eccentricity in its mounting, while not being too strong that it dampens rotation of the file.

In use, during assembly of an endodontic file 14 to the handpiece head 28, the contact element 20 is pushed backwards by the shank portion 22 of the endodontic file 14, compressing the spring 46 and thus maintaining good electrical contact between the endodontic file 14 and the device 10 even while the endodontic file 14 is rotating. Removal of the device 10 is not required for replacement of the endodontic file 14, although it may be easily removed for autoclave sterilization or for attachment to any other handpiece unit.

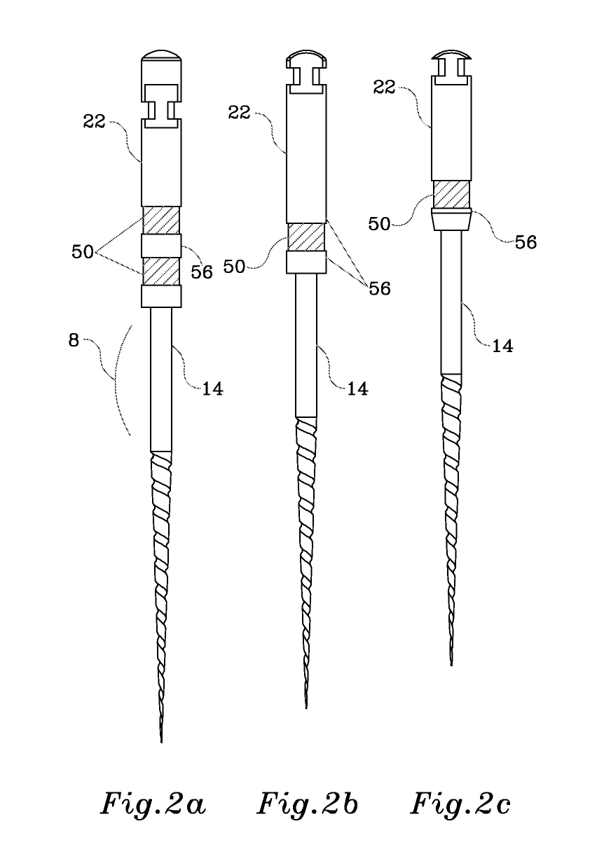

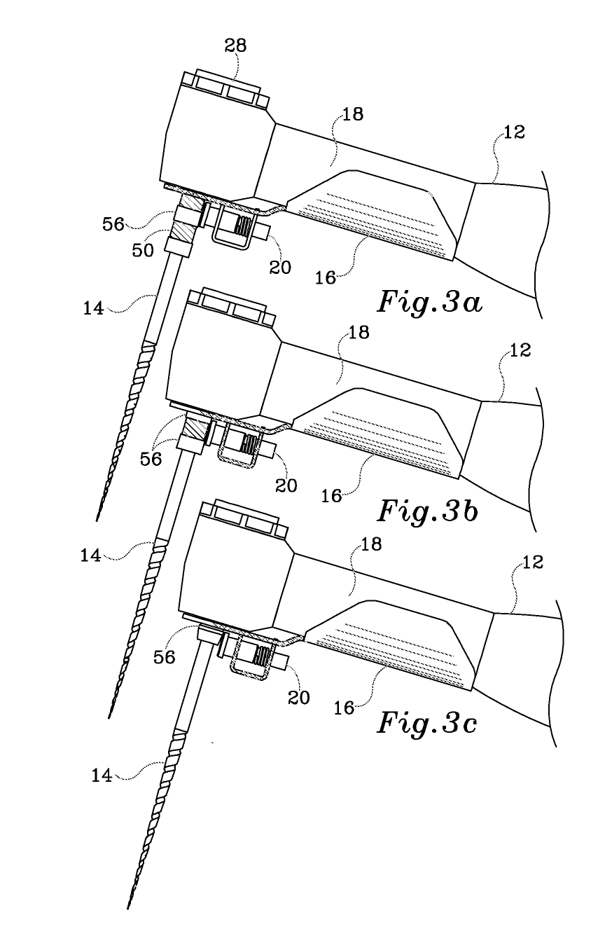

With reference to FIGS. 2a, 2b and 2c, commercially available rotary endodontic files are provided with various lengths of shank 22, each marked on specific locations along the shank 22 with color coding grooves 50 identifying the file size. The color coding is achieved by rings of different colors that are provided within the grooves. Since these rings are electrically insulating, it is important that the contact element 20 is larger that a width of the grooves so that it always makes contact with the surrounding electrically conductive shank. To this end, as shown in FIGS. 3a, 3b and 3c, the flat face 52 of the contact element 20 is of sufficient diameter, shown as D in FIG. 1, and is positioned to provide reliable contact with commercially available sizes of endodontic files, including those with short shank as shown in FIG. 3c and those that are provided along the shank with grooves for accommodating coding rings. As shown in the figures, the contact element is configured to straddle the grooves and thereby make electrical contact with the surrounding metallic smooth portions 56 on the outer surface of the shank 22. It will be noted that by using a shank portion as an electrical contact point, the electrical connection is steadier and the entire root canal length measurement device 10 has a very low profile imposing minimum interference with the dentist's work.

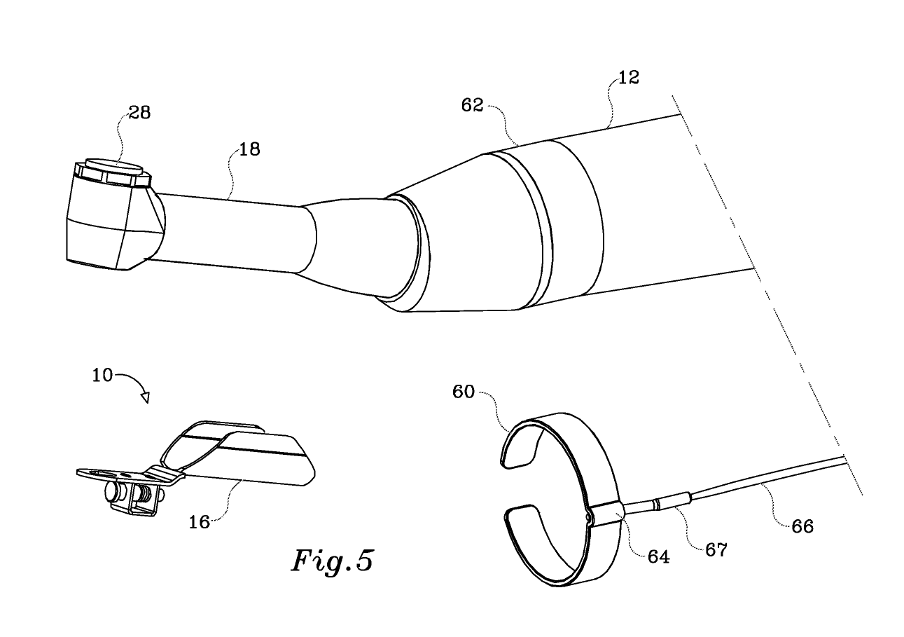

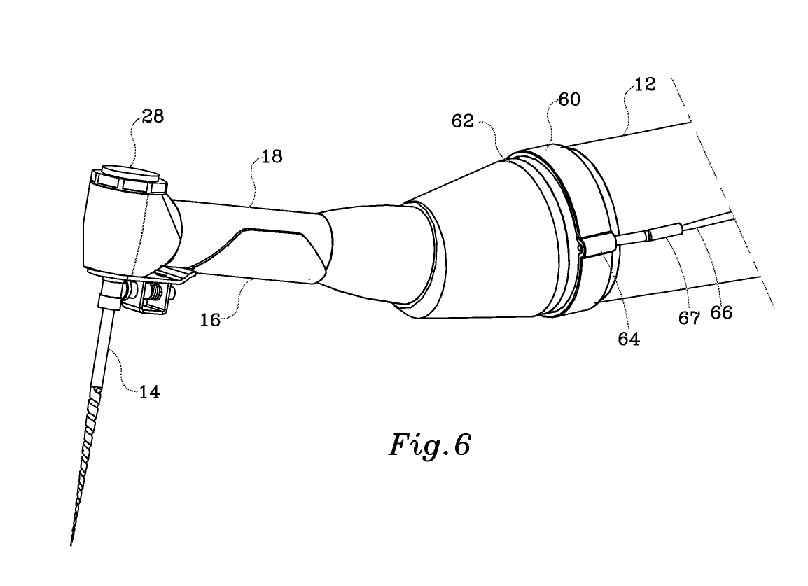

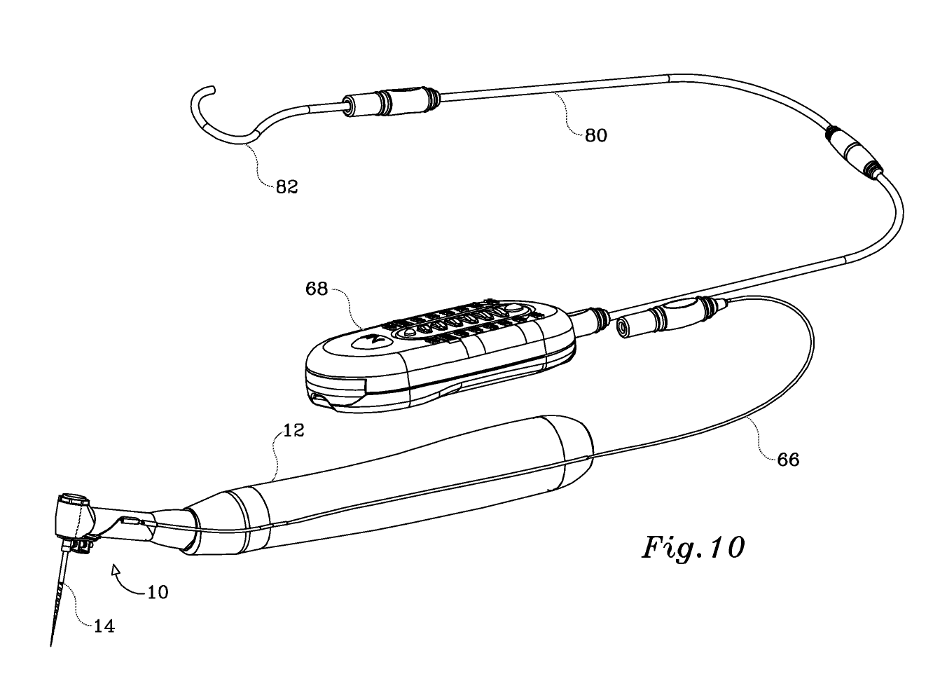

With reference to FIGS. 5 and 6, the electric circuit is closed by means of a metal ring 60 gripping the proximal thicker portion 62 of the metallic hand-piece neck 18. A portion of the metal ring 60 is crimped 64 as a socket for receiving an exposed end of a cord 66 or a plug 67 trimming the cord, the other end of which is plugged into an electronic control unit 68 (FIG. 10). It will be understood that in this embodiment the metallic hand-piece neck 18 serves as part of the electronic circuit, conducting an electric signal between the spring clip 16 and the metal ring 60.

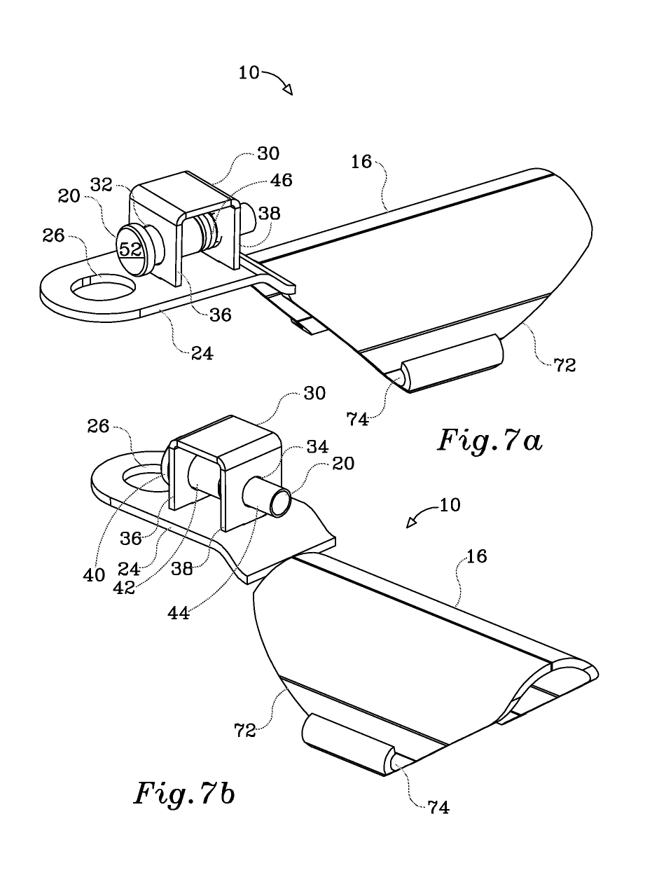

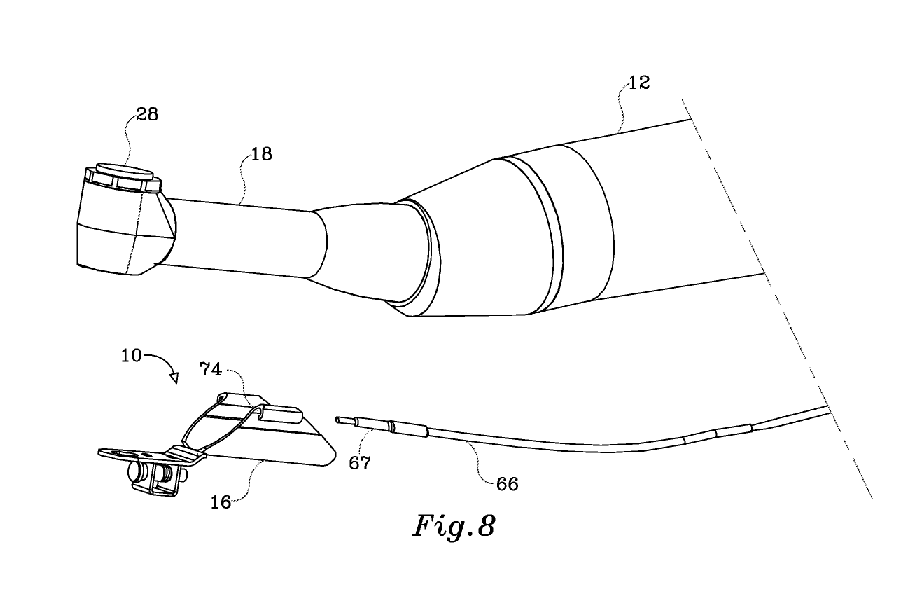

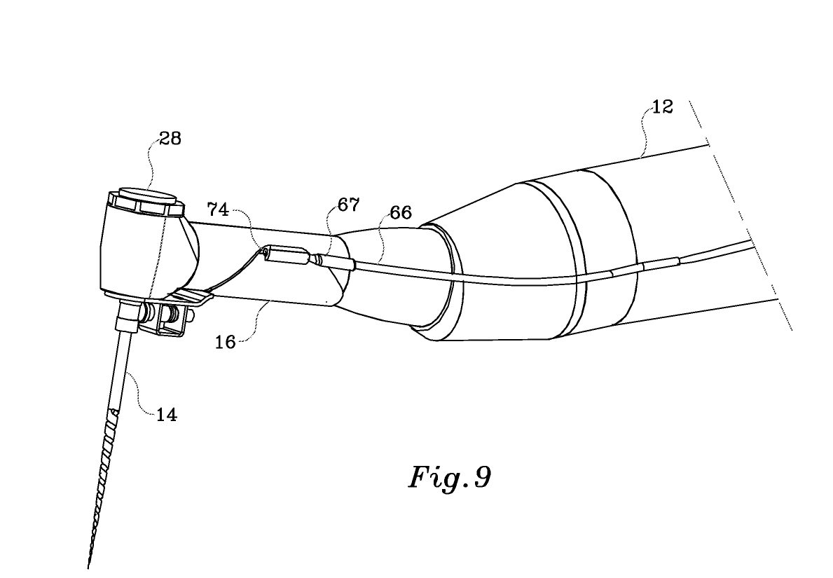

FIGS. 7, 8 and 9 show another embodiment having a spring clip 16 at least one of whose arms 72 is rolled outwardly forming a socket 74 into which the exposed end of the cord 66 or a plug 67 may be inserted to establish direct electrical connection between the spring clip 16 and the electronic control unit 68. This embodiment may serve hand-piece units that are not metallic or that are coated with a non-conductive protection layer.

FIG. 10 shows a complete system including the handpiece unit 12, the root canal length measurement device 10, the cord 66 leading to the electronic control unit 68 and a second cord 80 leading to the hook electrode 82 as known in the art.

It will be evident to those skilled in the art that the invention is not limited to the details of the foregoing illustrated embodiments and that the present invention may be embodied in other specific forms without departing from the scope of the appended claims.

1. A root canal length measurement device configured for detachable support on a neck of a dental handpiece and having a generally cylindrical electrical contact element that, in use, is resiliently biased by a spring toward an endodontic file rotatably mounted in the handpiece so that a flat surface of the contact element maintains a steady electrical connection with a shank portion of the endodontic file proximate its point of attachment to the handpiece.

2. The root canal length measurement device according to claim 1, comprising an elongated spring clip configured to grip a neck of the handpiece and supporting at a first end thereof a flat faced spring-loaded contact element directed to maintain a steady electrical connection with a shank portion of said endodontic file proximate its point of attachment to the handpiece.

3. The root canal length measurement device according to claim 2, wherein said longitudinal spring clip is of a C-shaped cross section.

4. The root canal length measurement device according to claim 2, wherein said longitudinal spring clip has a flat extension at a first end.

5. The root canal length measurement device according to claim 4, wherein said spring clip and extension are formed of a unitary thin sheet of resilient electrically conductive material.

6. The root canal length measurement device according to claim 4, wherein the extension is elongated so as to overhang the point of attachment of the endodontic file in the head of the handpiece and is perforated with a hole through which the endodontic file is fitted to and removed from the point of attachment.

7. The root canal length measurement device according to claim 6, wherein said hole is elongated so as to allow for fine adjustment of contact pressure by moving the spring clip along the neck of the handpiece.

8. The root canal length measurement device according to claim 4, wherein the spring-loaded contact element is slidably supported within a holder made of a short tunnel section transversely attached to an outer surface of the extension in an opposite direction to opposing arms of the spring clip.

9. The root canal length measurement device according to claim 8, wherein a circular first aperture and a circular second aperture mutually parallel with a longitudinal axis of the root canal length measurement device are formed through respective opposing walls of the tunnel shaped holder.

10. The root canal length measurement device according to claim 9, wherein said first aperture is closer to said hole than the second aperture and is of larger diameter than the second aperture.

11. The root canal length measurement device according to claim 10, wherein said cylindrical contact element includes a short flat faced head coaxially abutting a body section of lesser diameter than the head and coaxially abutting a tail section of lesser diameter than the body section.

12. The root canal length measurement device according to claim 11, wherein said body section is adapted to slide freely in the first aperture of the holder and the tail section is adapted to slide freely in the second aperture.

13. The root canal length measurement device according to claim 12, wherein the spring is a helical coil compression spring having an internal diameter slightly larger than the diameter of the tail section, said spring being fitted to the contact element around the tail section between a shoulder and the second wall of the holder.

14. The root canal length measurement device according to claim 1, for used with commercially available endodontic files having color-coded grooves, wherein the flat face of said contact element is larger than a width of said grooves.

15. The root canal length measurement device according to claim 14, wherein the file has metallic smooth portions on an outer surface of the shank, and the contact element is configured to make electrical contact with the metallic smooth portions.

16. The root canal length measurement device according to claim 2, wherein an electric circuit of the root canal length measurement root canal length measurement device is closed by means of a metal ring gripping an electrically conductive portion of the hand-piece.

17. The root canal length measurement device according to claim 16, wherein a portion of the metal ring is crimped as a socket for receiving an exposed end of a cord or plug trimming said cord, an opposite end of which is plugged into an electronic control unit, and the electrically conductive portion forms part of the electric circuit for conducting an electrical signal between the spring clip and the metal ring.

18. The root canal length measurement device according to claim 2, wherein said spring clip is provided with a socket into which an exposed end of a cord or a plug trimming said cord, may be engaged to establish direct electrical connection between the spring clip and an electronic control unit through said cord.

19. The root canal length measurement device according to claim 2, wherein said spring clip is provided with a plug on which a socket trimming a cord, may be engaged to establish direct electrical connection between the spring clip and an electronic control unit through said cord.

20. The root canal length measurement device according to claim 18, wherein at least one arm of said spring clip is rolled outwardly to form said socket.
